(19) United States
(12) Patent Application Publication
(10) Pub. No.: US 2005/0148830 A1
(43) Pub. Date: Jul. 7, 2005

(54) Computerized medical and dental diagnosis and treatment planning and management system

(76) Inventor: G. William Arnett, Santa Barbara, CA (US)

Correspondence Address: CHRISTIE, PARKER & HALE, LLP, PO BOX 7068, PASADENA, CA, 91109-7068, US

(21) Appl. No.: 11/004,722

(22) Filed: Dec. 3, 2004

Related U.S. Application Data
(60) Provisional application No. 60/527,039, filed on Dec. 3, 2003.

(51) Int. Cl. G06F 17/60

(52) U.S. Cl. 600/300; 705/3

(57) ABSTRACT

A computerized medical and dental diagnosis and treatment planning and management system. The system includes a menu based computer program with fields for entering information including answers to questions and measured data related to a plurality of different types of examinations, wherein the entered information in specific fields on specific forms for one type of examination will automatically populate selected data fields in a series of other forms for other types of examinations. The forms are electronically disseminated from a central system by one treating practitioner to other practitioners who render service to a patient.

### CROSS-REFERENCE TO RELATED APPLICATIONS

This application claims the benefit of provisional patent application no. 60/527,039 entitled “COMPUTERIZED MEDICAL AND DENTAL DIAGNOSIS AND TREATMENT PLANNING AND MANAGEMENT SYSTEM”, filed on Dec. 3, 2003.

### BACKGROUND OF THE INVENTION

The invention is related to the field of diagnosis and treatment planning systems. More particularly, the invention relates to a computerized medical and dental diagnosis and treatment planning and management system that permits a health care worker such as a surgeon, orthodontist or dentist to navigate through a menu-based computer program, and answer questions and enter data relevant to specific types of examinations. The answered questions and entered data in specific fields and on specific forms then populate data fields in a series of other forms which can list at least some of the following items: diagnosed conditions and findings; possible treatment for those conditions and findings; specific actions that can be taken to attend to the diagnosed conditions and findings; and referrals to other professionals. Any change of data or entered information on any one form or data field will automatically update other related forms as needed.

Presently, not all practitioners in specialty or even generalized medical and dental practices may be knowledgeable or ideally suited to carry out examinations or treatments in different fields. As an example, an orthodontist operating out of an orthodontic office may not be equipped to render one or more specific examinations, such as a periodontal examination, a dental examination, a bite examination, a temporomandibular joint or “TMJ” examination, a facial examination, and a cephalometric examination. Moreover, even if such orthodontists can confidently and competently carry out such varied examinations, they may not be well-equipped to carry out all the recommended treatments.

Moreover, a working practitioner in a field such as orthodontics, who may have a busy patient load, may not always be apprised of the newest treatment options in other fields, such as maxillofacial and orthognathic surgery or TMJ conditions.

It is also a possibility that a practitioner may not be well-connected or personally acquainted with other practitioners in other specialty areas, and therefore may not be able to confidently make referrals.

Additionally, if a referral is made, considerable effort can be expended in ensuring that the other practitioner(s) have the necessary medical records, treatment recommendations, and that the treatments by the different professionals will be coordinated, so that the referring practitioner (e.g. an orthodontist) can be assured that the various treatments are carried out so that desired results are reached. Indeed, this can involve faxing records, making numerous telephone calls, writing letters, and the like, all of which require valuable time and effort on the part of the referring practitioner and his or her staff.

Medical and dental technology, and a patient's condition and desires are not static, and there is always the possibility that a specialist may decide to change the treatment sometime after an initial recommendation. Since changes in treatments may impact what other specialists plan on or are doing, it is desirable for there to be a central repository for patient records and data to help ensure that the most current recommendations and/or modified treatments from the referring practitioner or another specialist are accurately reflected in the referral practitioner's and other practitioner's records and/or accessible therein.

Many medical and dental professionals continue to largely practice in an environment based on paper records and files. One advantage of such paper files and records is their portability. A medical practitioner can carry files from room to room in an office, easily review information, make notes and then easily switch to another file and patient. The newly entered information on paper records may or may not be used to update electronic files. A downside to these paper files is that they must be stored when not in use (which is the vast majority of the time), located and provided to the practitioner in advance of a patient appointment, and then returned afterwards. Moreover, as noted above, if a practitioner decides to refer out a patient to other specialists, someone must forward a copy of at least part of the records, along the requested task. This is cumbersome and is typically handled by letter, fax and/or email, and requires additional effort and expense on the practitioner and his or her staff, for which the referring physician is often not compensated.

Medical and dental offices have increasingly taken advantage of computer hardware and software to ensure that their practices run more efficiently. Practice management and scheduling software, and patient records and treatment planning software enjoy widespread acceptance. However, the inventor is unaware of any systems or software applications that facilitate effective collaboration between different offices and specialists, so that the efforts of different professionals can work effectively to achieve a common goal of patient treatment with the least amount of inconvenience and error.

### SUMMARY OF THE INVENTION

The invention provides a computerized medical and dental diagnosis and treatment planning and management system. The system permits a health care worker, such as a surgeon, an orthodontist, a dentist and others at a medical or dental office, who is meeting with a patient either for the first time or for a repeat visit, to navigate through a menu-based computer program, and answer questions and enter data related to specific types of examinations. The entered data and answers in specific fields and on specific forms then populates data fields in a series of other forms which can list at least some of the following items: diagnosed conditions and findings; possible treatment for those conditions and findings; specific action items that can be taken to attend to the diagnosed conditions and findings; and referrals to other professionals. Any change of data or entered information on any one form or data field will automatically update other related forms as needed.

One aspect of the invention provides a computerized medical and dental diagnosis and treatment planning and management system wherein information can be electronically disseminated from a central system by a referring practitioner to other specialists.

Another aspect of the invention is a computerized medical and dental diagnosis and treatment planning and management system that provides all feasible treatment options for a variety of conditions in the relevant fields.

Yet another aspect of the invention is a computerized medical and dental diagnosis and treatment planning and management system that permits a health care worker such as a surgeon, orthodontist or dentist to navigate through a menu-based computer program, and answer questions and enter data relevant to specific types of examinations. The answered questions and entered data in specific fields and on specific forms then populates data fields in a series of other forms which can list at least some of the following items: diagnosed conditions and findings; possible treatment for those conditions and findings; specific actions that can be taken to attend to the diagnosed conditions and findings; and referrals to other professionals. Any change of data or entered information on any one form or data field will automatically update other related forms as needed.

### BRIEF DESCRIPTION OF THE DRAWINGS

FIG. 1 is a flowchart showing a structure of an exemplary embodiment of the computerized medical and dental diagnosis and treatment planning and management system of the invention.

FIGS. 2-4 are flowcharts showing various exemplary drop down lists accessible within different portions of the system of FIG. 1.

FIG. 5 is a diagram showing various examination links available through a diagnosis central portion of the system.

FIG. 6 is a diagram showing an exemplary TMJ examination form selected through the diagnosis central portion of the system of FIG. 5, with various referral options being shown.

FIGS. 7A and 7B are an exemplary TMJ examination form of the system.

FIGS. 7C-E is an exemplary facial examination form of the system.

FIG. 7F is an exemplary patient motivation questionnaire of the system.

FIG. 8 is a flowchart of FIG. 1, but with a treatment central summary selected.

FIGS. 9A-9C are views of an exemplary treatment central summary form of the system.

FIG. 10 is a flowchart of FIG. 1, but with a referral central summary selected.

FIGS. 11A and 11B are views of an exemplary referral central summary form of the system.

FIG. 12 is a flowchart of FIG. 1, but with a procedure central summary selected.

FIGS. 13A-13C are views of an exemplary procedure central summary form of the system.

### DETAILED DESCRIPTION OF THE INVENTION

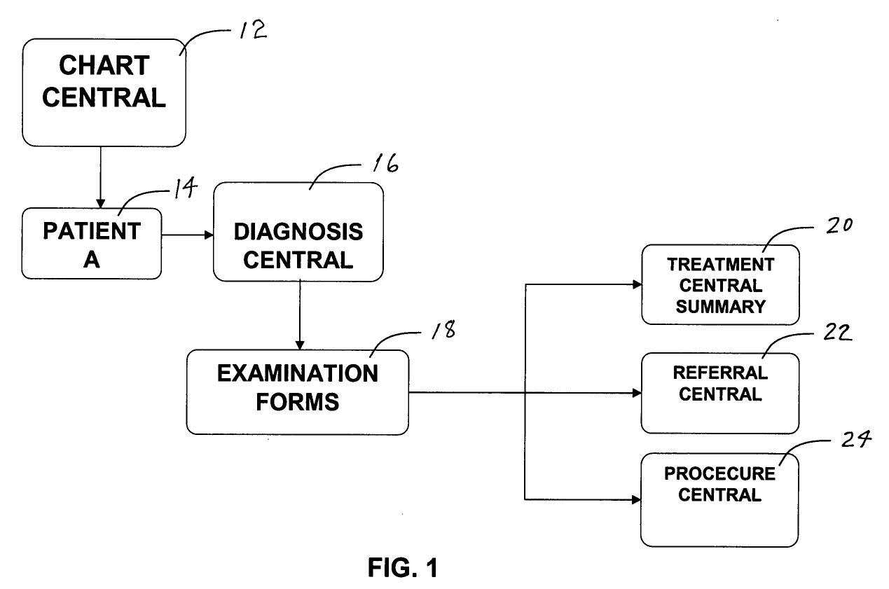

Referring to FIG. 1, there is shown a flowchart showing a structure of an exemplary embodiment of the computerized medical and dental diagnosis and treatment planning and management system 10 of the invention. The system includes a so-called “Chart Central” 12, which is a software system for storing data such as patient data, information concerning various possible treatment and data concerning those treatments, and information concerning other providers of goods and services. A patient (Patent A) 14 will be seen by a health care provider and will be diagnosed by a “Diagnosis Central” 16 of the system. The diagnosis central 16 will have an examination forms module 18 that can display information in summary form. In an embodiment of the system, a treatment central summary 20, a referral central 22 and a procedure central 24 can be provided. The instantly described system in FIG. 1 is a flowchart showing a structure of an exemplary embodiment of the computerized medical and dental diagnosis and treatment planning and management system of the invention.

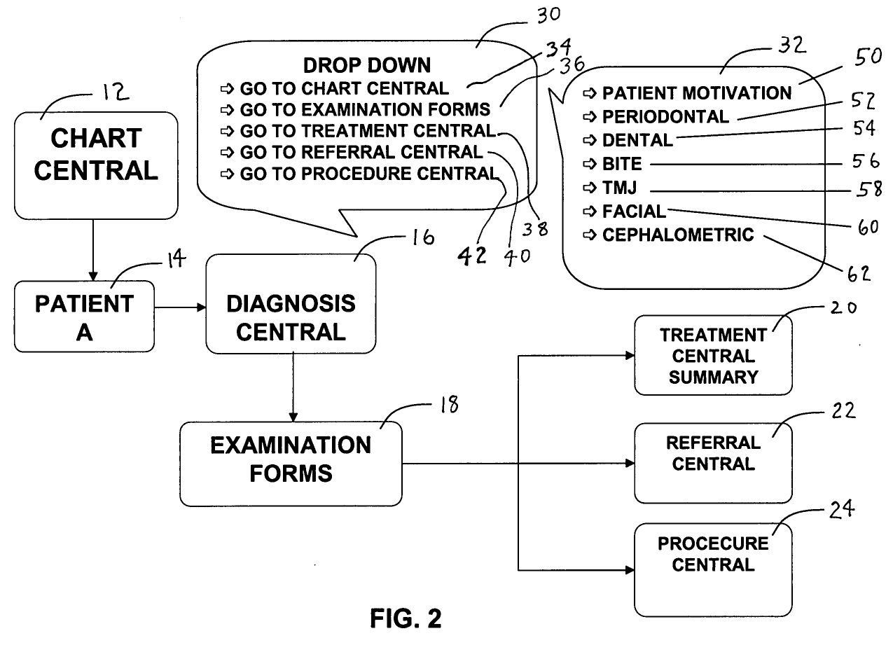

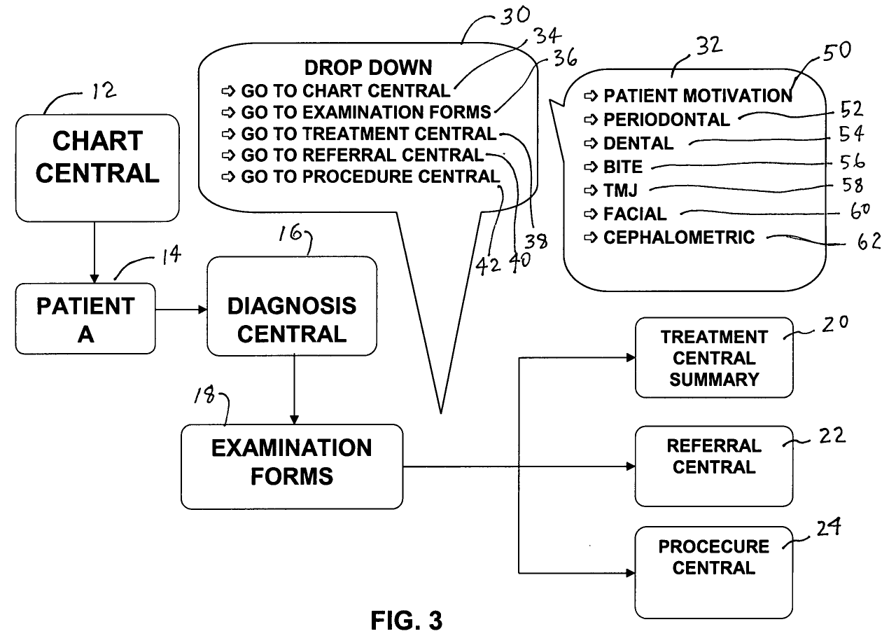

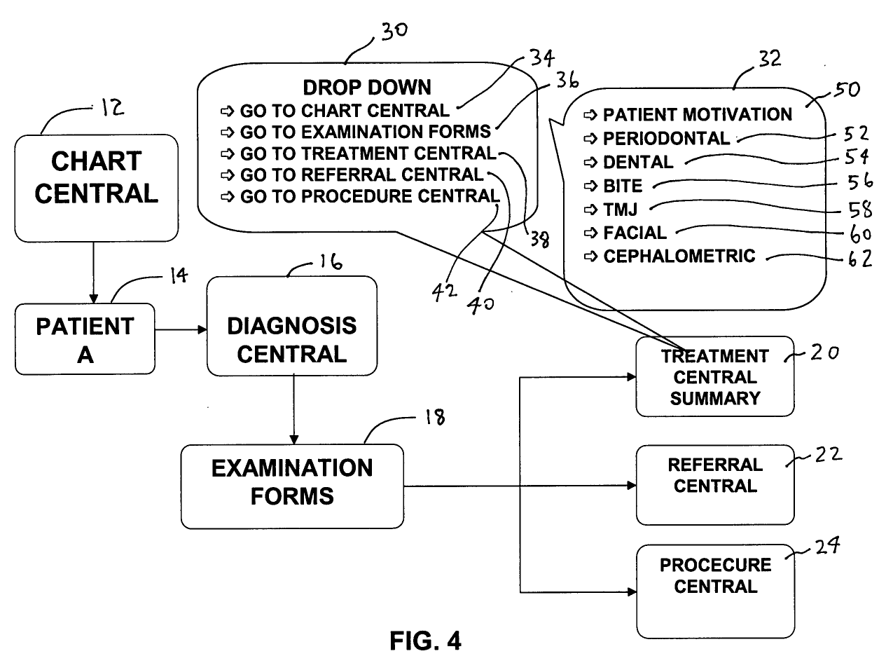

FIGS. 2-4 are flowcharts showing various exemplary drop down menus 30 and 32 that are accessible within different portions of the system of FIG. 1. As can be seen, the system permits a health care provider to move from any point in the system to any other point in fewer steps, which saves effort in having to navigate through multiple screens. As an example, and as shown in FIGS. 2-4, drop down menu 30 can be selected from diagnosis central 16, examination forms 18, and treatment central summary 20. Although not shown, drop down menu 30 can likewise be selected and accessed as it includes the ability to select “GO TO CHART CENTRAL” 34, “GO TO EXAMINATION FORMS” 36, “GO TO TREATMENT CENTRAL” 38, “GO TO REFERRAL CENTRAL” 40, and “GO TO PROCEDURE CENTRAL” 42. If, for example, a user selected “GO TO EXAMINATION FORMS” 36, the further pop up menu 32 appears with the exemplary choices of “PATIENT MOTIVATION” 50, “PERIODONTAL” 52, “DENTAL” 54, “BITE” 56, “TMJ” 58, “FACIAL” 60, and “CEPHALOMETRIC” 62.

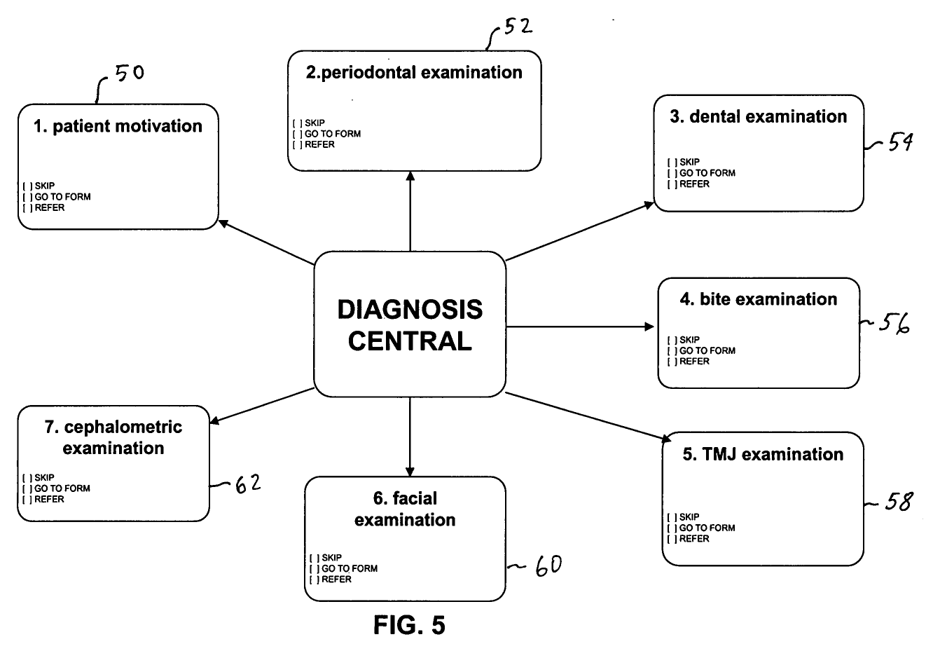

FIG. 5 is a diagram showing various examination links available through exemplary diagnosis central portion 16 of the system, namely patient motivation 50, periodontal examination 52, dental examination 54, bite examination 56, TMJ examination 58, facial examination 60, and cephalometric examination 62. Different and/or additional examinations can be added.

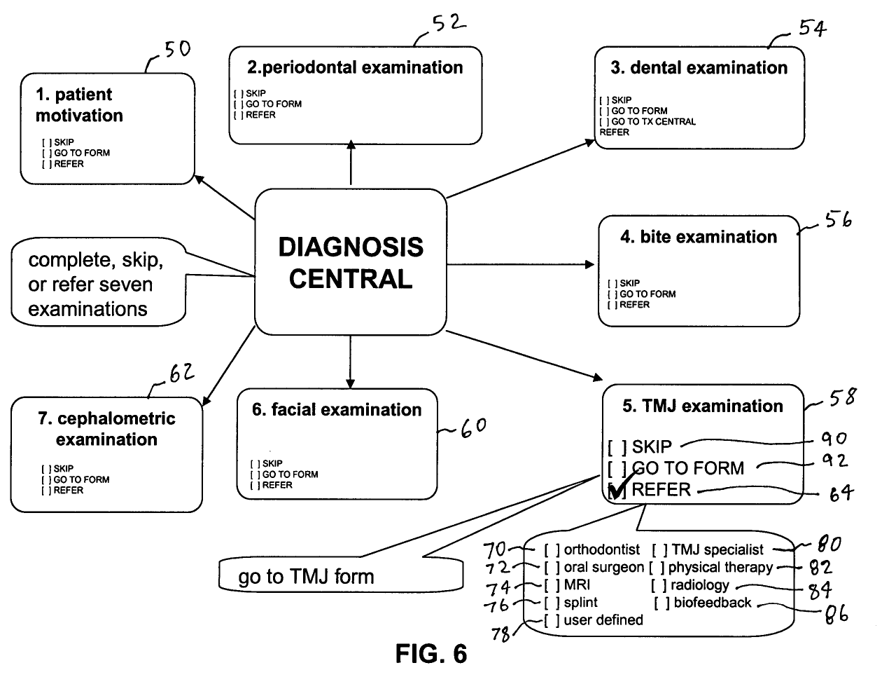

FIG. 6 is a diagram showing the exemplary TMJ examination form 58 selected through the diagnosis central portion 16 of the system of FIG. 5, with various referral options being shown in a “REFER” option 64, namely orthodontist 70, oral surgeon 72, MRI 74, splint 76, user defined 78, TMJ specialist 80, physical therapy 82, radiology 84 and biofeedback 86. Other options at the TMJ examination 58 include a “SKIP” option 90, and a “GO TO FORM” option 92. While not shown, a “REFER” option, a “SKIP” option, and a “GO TO FORM” option are preferably provided at each of the examinations and patient motivation forms to assist with navigating the system.

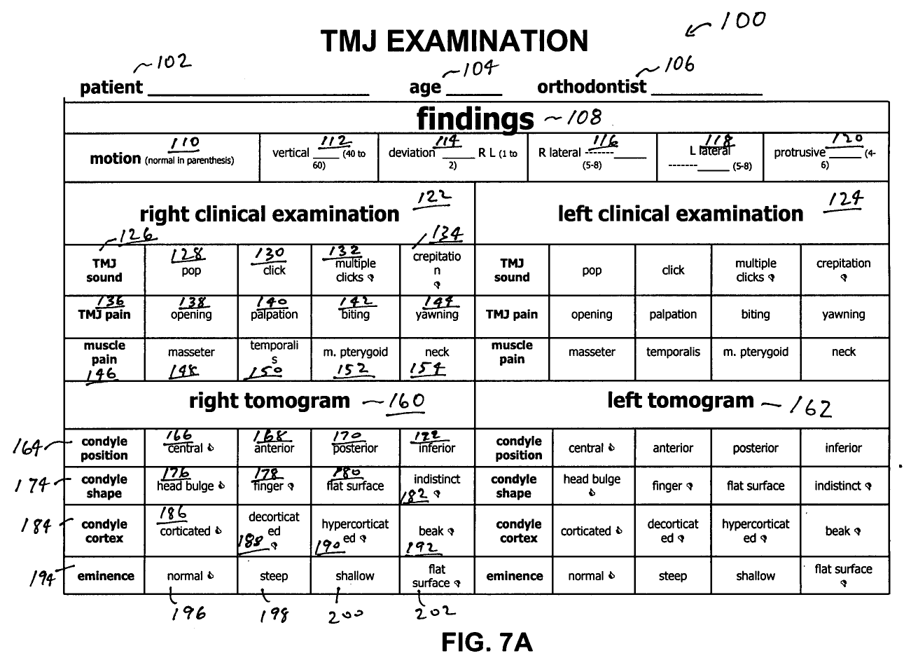

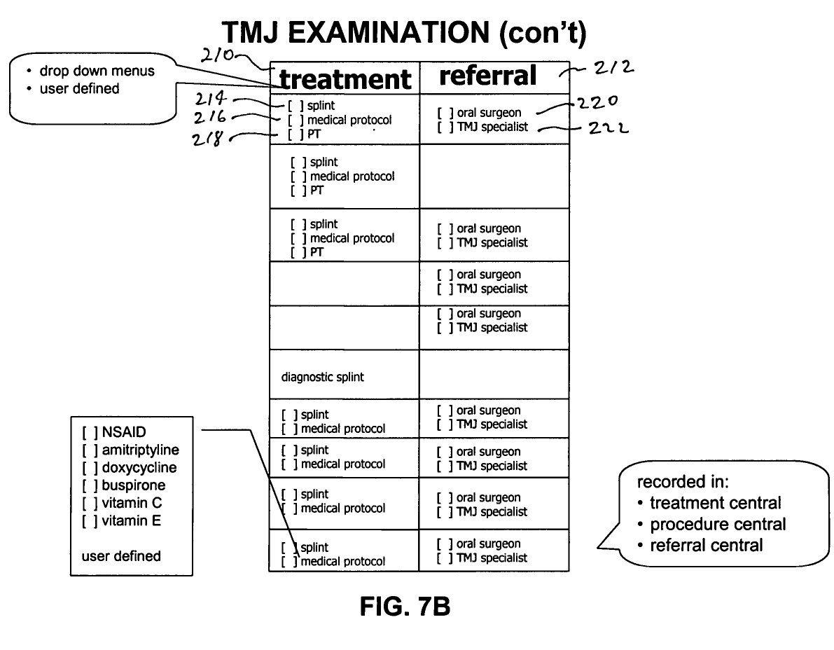

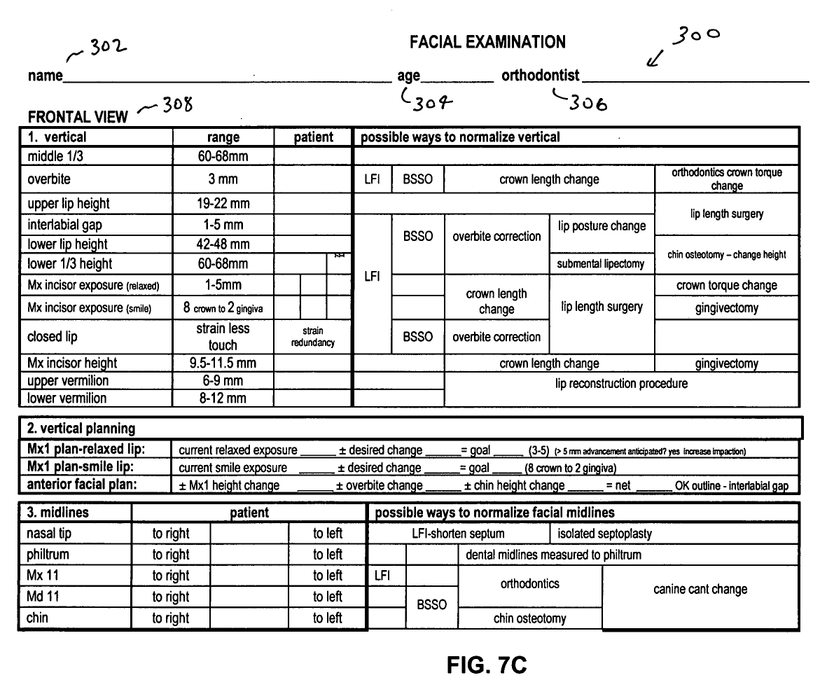

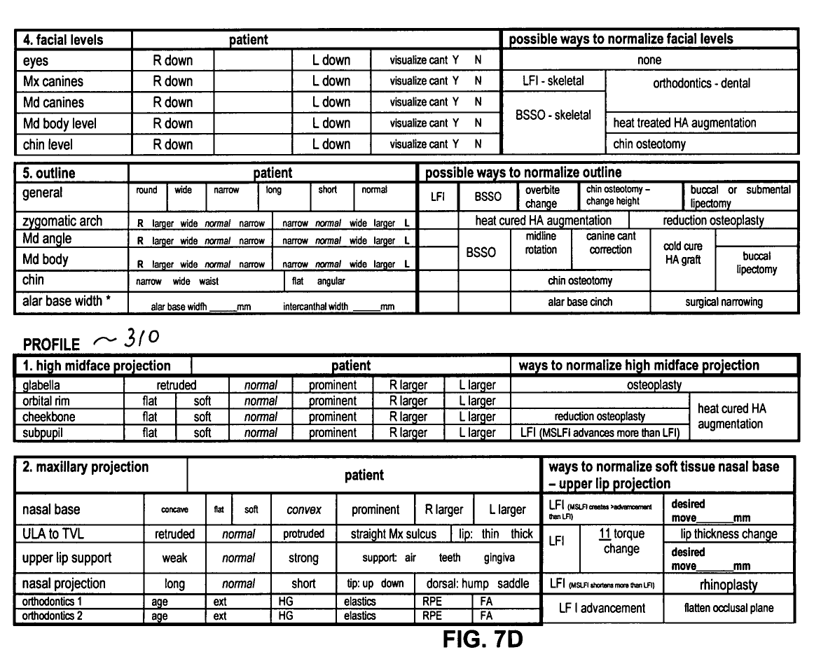

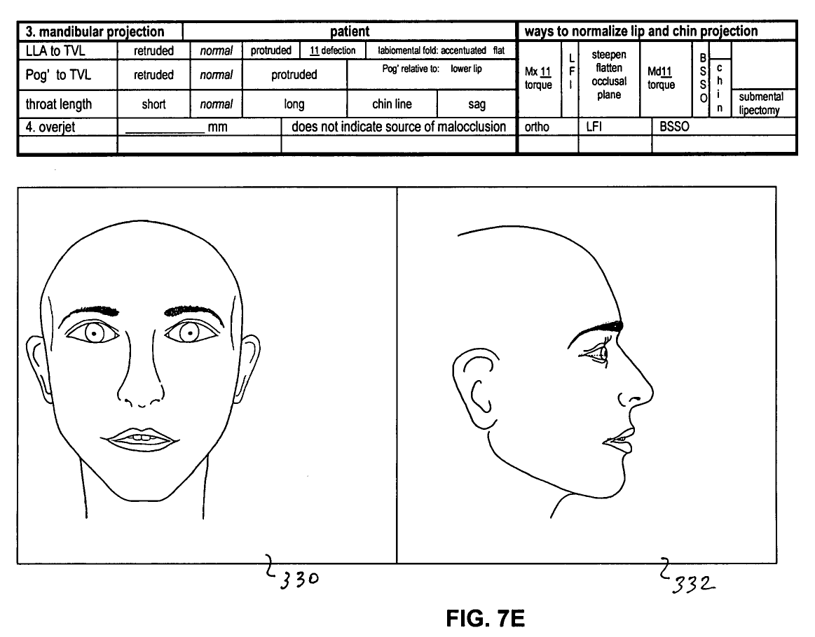

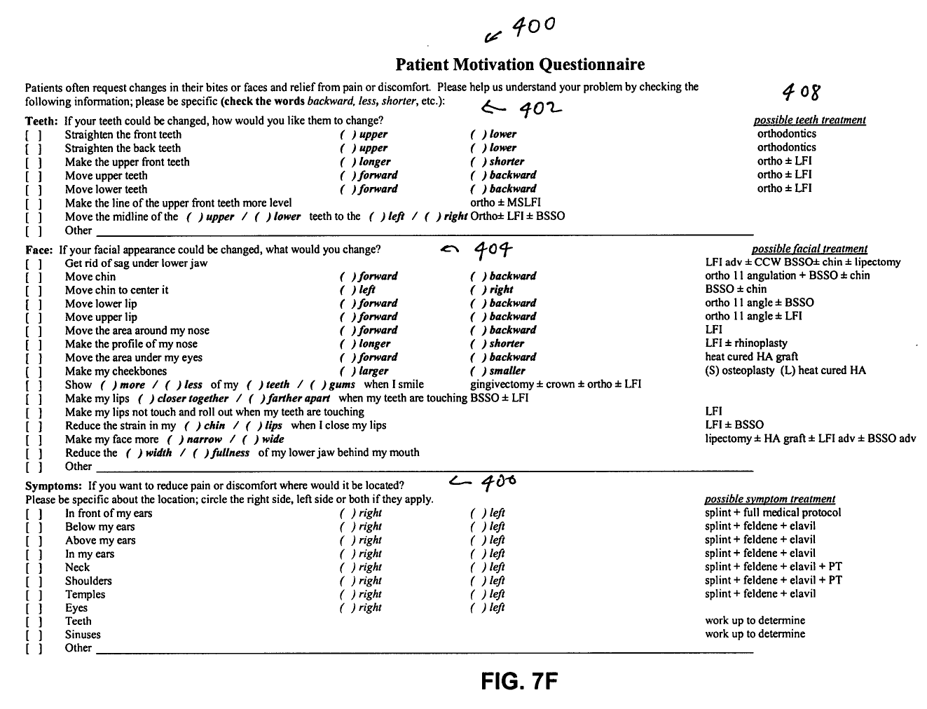

FIGS. 7A and 7B are an exemplary TMJ examination form 100 of the system. It preferably has fields for patient information, such as patient name 102, age 104, and orthodontist 106. A “FINDINGS” field 108 provides fields for motion 110, including vertical 112, deviation 114, right lateral 116, left lateral 118, and protrusive 120. There is preferably a right clinical examination field 122 and a left clinical examination field 124, each of which has further fields, including TMJ sound 126 (with options including pop 128, click 130, multiple clicks 132, and crepitation 134, etc.), TMJ pain 136 (with options including opening 138, palpation 140, biting 142 and yawning 144), and muscle pain 146 (with options including masseter 148, temporalis 150, m. pteygoid 152 and neck 154. There is a right tomograph field 160 and left tomograph field 162, each of which has further fields, including condyle shape 164 (with options including central 166, anterior 168, posterior 170 and inferior 172, condyle position 174 (with options including head bulge 176, finger 178, flat surface 180 and indistinct 182), condyle cortex 184 (with options corticated 186, decorticated 188, hypercorticated 190, and beak 192), and eminence 194 (including options including normal 196, steep 198, shallow 200, and flat surface 202). For each of the findings 108, right and left clinical examinations 122 and 124, respectively, and right and left tomograph 160 and 162, respectively, there are various treatment options 210 and referral options 212, each with drop down menus. The treatment options 210 can include, for example, splint 214, medical protocol 216 and physical therapy (PT) 218. The referral options 212 can include, for example, oral surgeon 220 and TMJ specialist 222. When a user of the system makes a selection in the TMJ examination form 100, these changes automatically update all the other forms, e.g. at treatment central, procedure central, and referral central.

FIGS. 7C-E is an exemplary facial examination form 300 of the system. It has fields for the patient's name 302, age 304 and orthodontist 306. This information will be automatically filled in if another form was previously completed that has corresponding fields. The examination provides for frontal examination 308 and a profile examination 310. Various fields can be provided to permit a health care provider to carry out a complete examination including making observations, recording patient details, and having suggestions made as to possible ways to normalize features. A patient's front facial view 330 and profile facial view 332 can be shown by the system.

FIG. 7F is an exemplary patient motivation questionnaire 400, with a series of questions concerning possible changes to a patient's teeth 402, face 404 and symptoms 406, and possible treatments 408 to affect these changes desired by the patient. While the questions shown in the FIGS. are directed to facial and dental conditions, other types of questions can be asked.

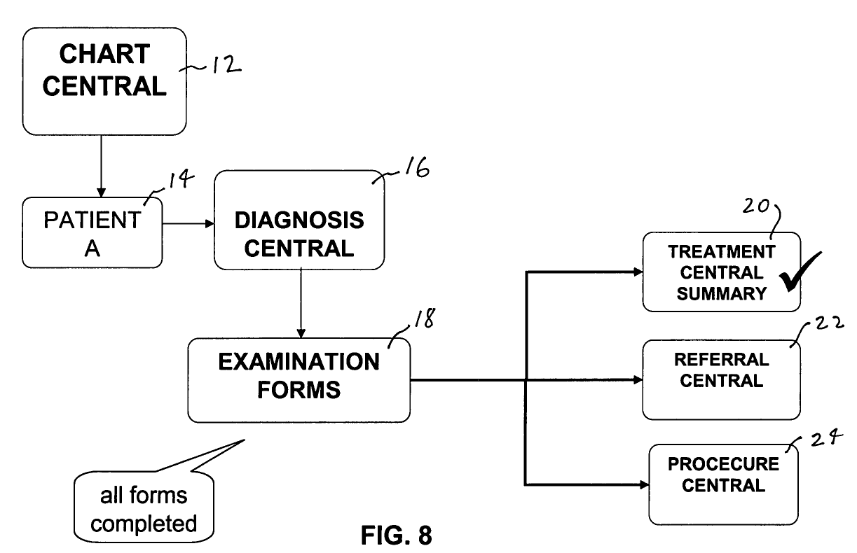

FIG. 8 is a flowchart of FIG. 1, but with all examination forms 18 completed, and with the treatment central summary 20 selected.

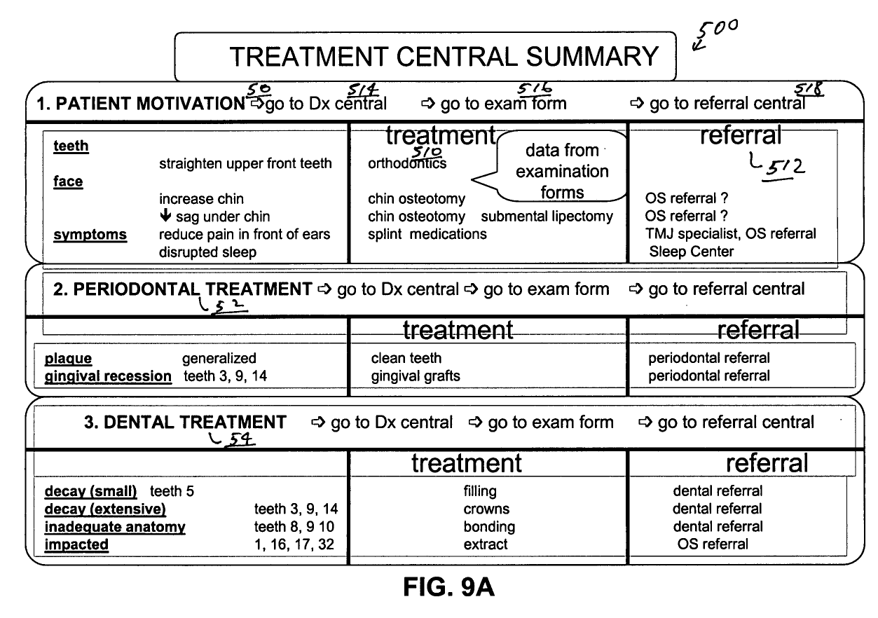

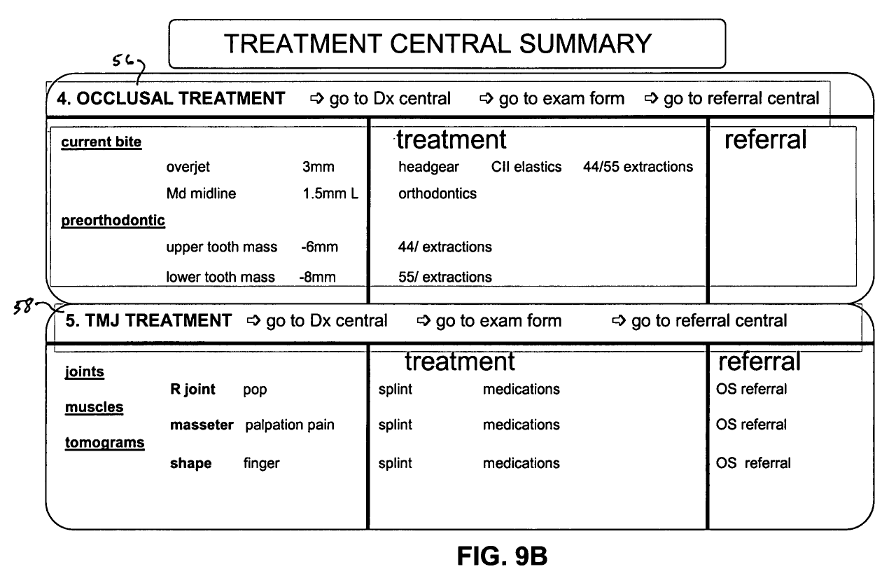

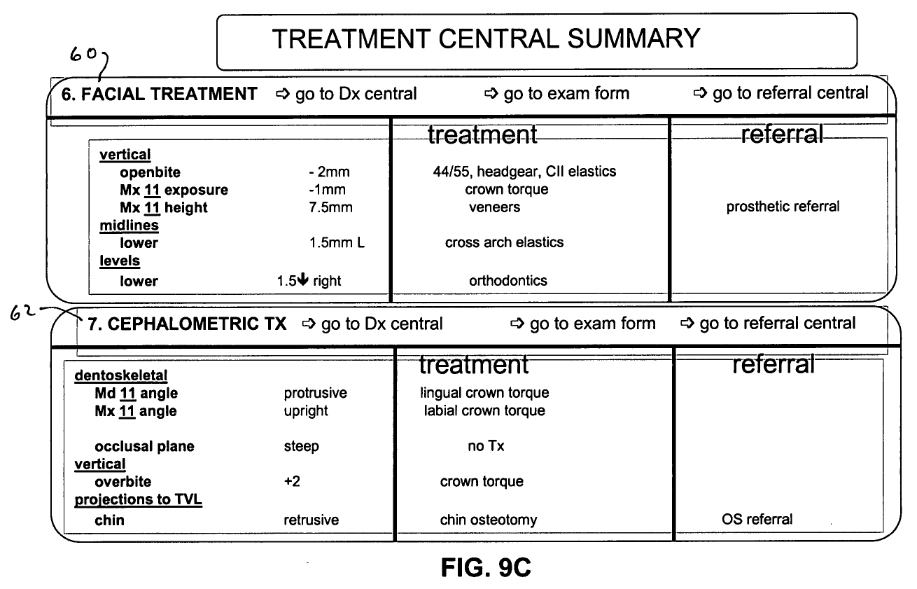

FIGS. 9A-9C are views of an exemplary treatment central summary display 500 of the system. It will display information from the completed forms, namely data from the patient motivation 50, periodontal examination 52, dental examination 54, occlusal treatment (or bite examination) 56, TMJ examination 58, facial examination 60, and cephalometric examination 62; treatments 510 for each of these from data gleaned from the examination forms, and possible referrals 512. Within this display, a user can easily select to go to Dx (Diagnosis) central 514, go to exam (examination) forms 516 and go to referral central 518, saving the user time in navigating the system.

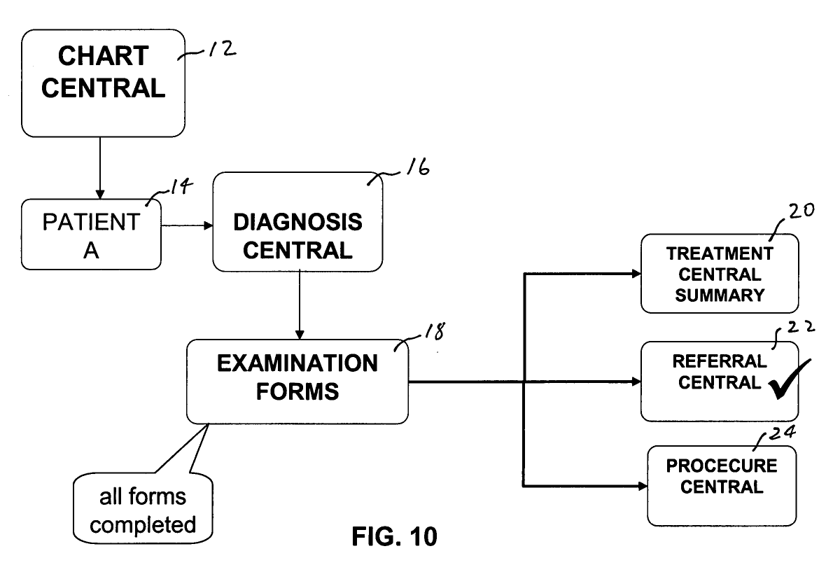

FIG. 10 is a flowchart of FIG. 1, but with all examination forms 18 completed, and with the referral central summary 22 selected.

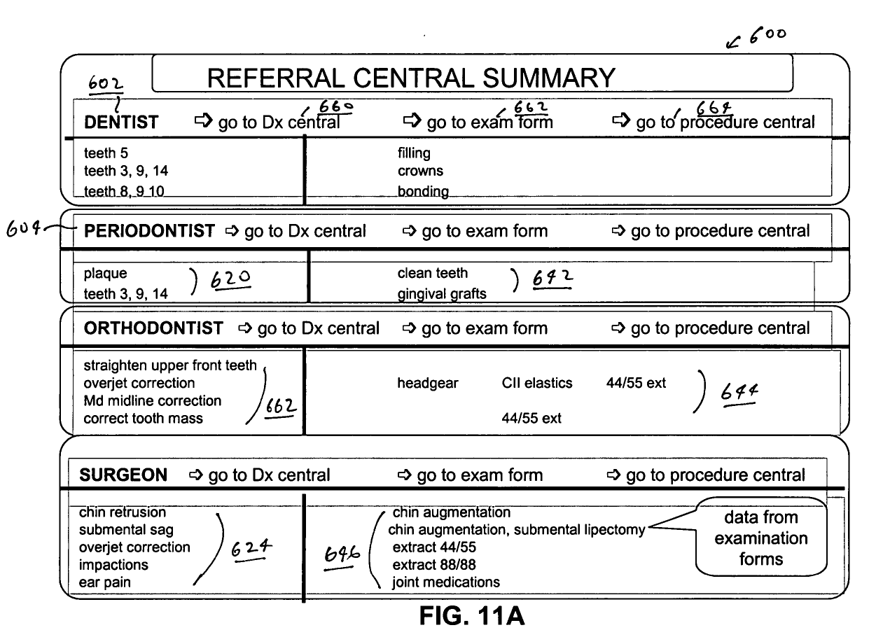

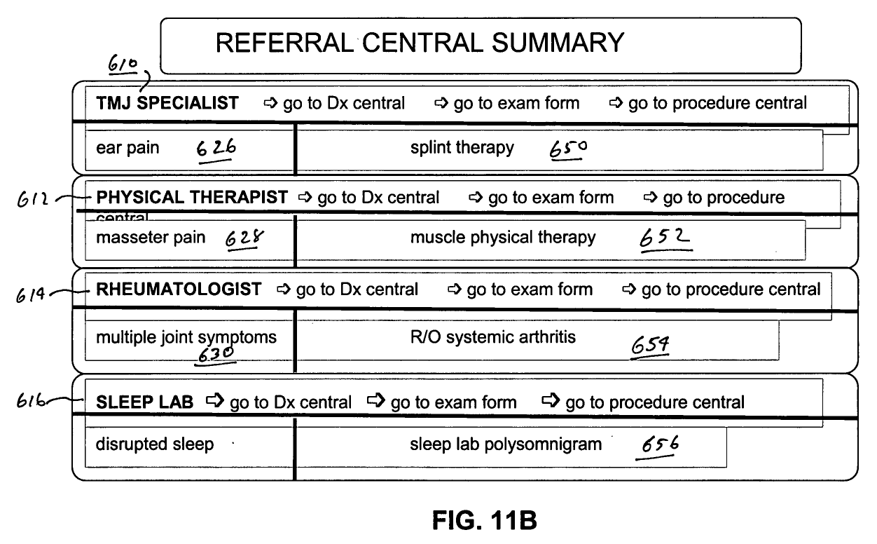

FIGS. 11A and 11B are views of an exemplary referral central summary display 600 of the system. In this display, the various health care professional who can be involved with various aspects of treatment are listed, including Dentist 602, Periodontist 604, Orthodontist 606, Surgeon 608, TMJ specialist 610, Physical Therapist 612, Rheumatologist 614 and Sleep Lab 616. The various conditions and/or problems to be addressed by each health care provider will be listed in fields, namely fields 618, 620, 622, 624, 626, 628, 630 and 632, respectively, along with actions needed to be taken by each health care provider, namely 640, 642, 644, 646, 650, 652, 654 and 656, respectively. Within this display, a user can easily select to go to Dx (Diagnosis) central 660, go to exam (examination) forms 662 and go to procedure central 664, saving the user time in navigating the system.

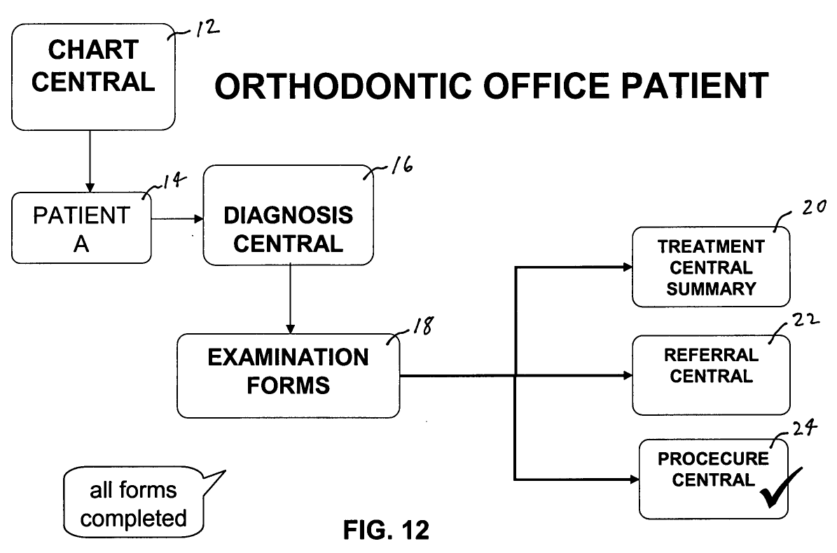

FIG. 12 is a flowchart of FIG. 1, but with all examination forms 18 completed, and with the procedure central summary selected 24.

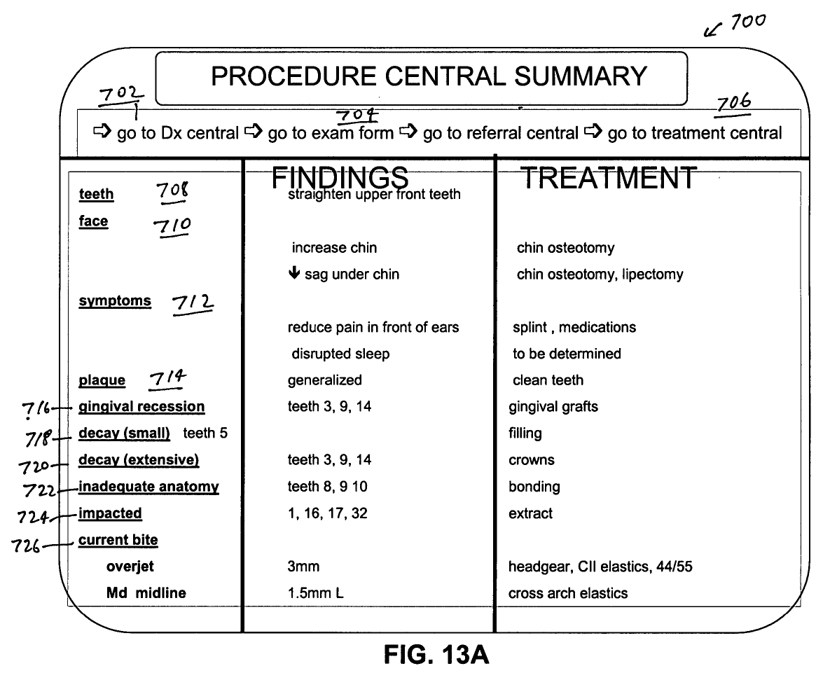

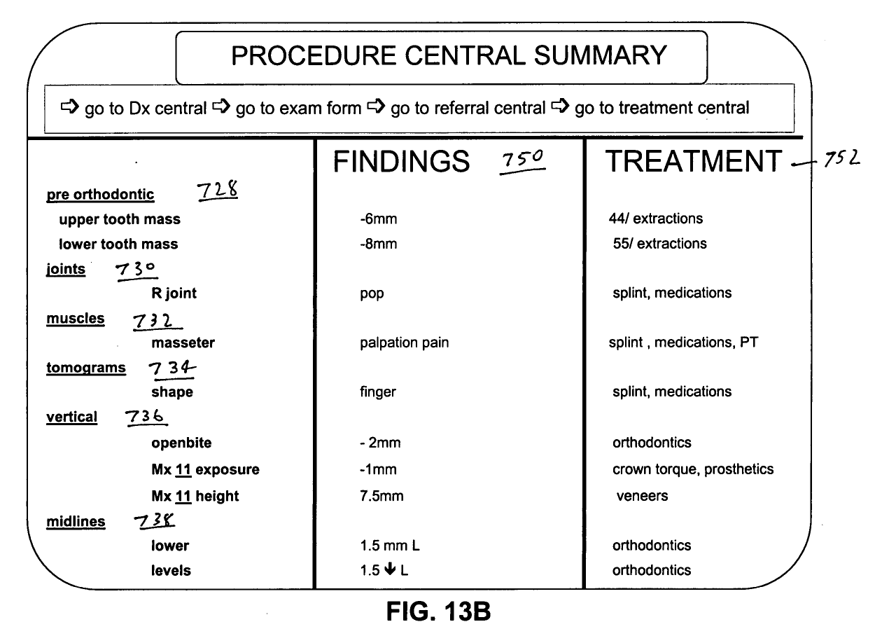

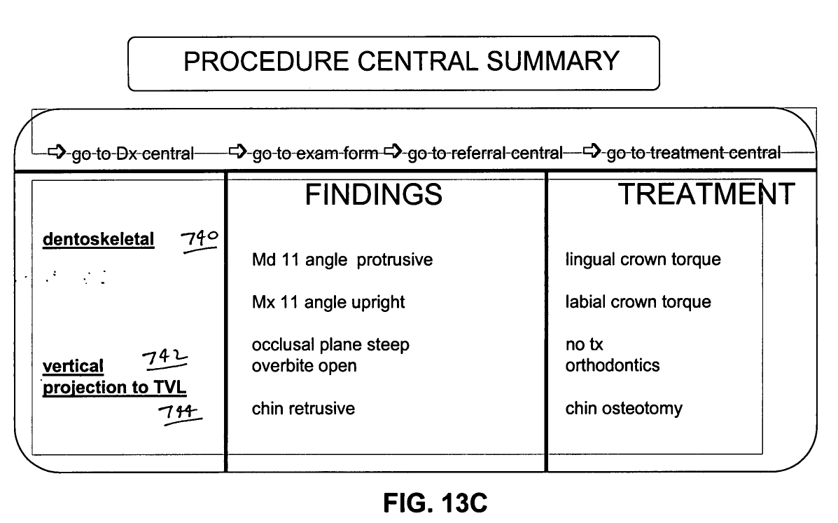

FIGS. 13A-13C are views of an exemplary procedure central summary display 700 of the system. Within this display, a user can easily select to go to Dx (Diagnosis) central 702, go to exam (examination) form 704 and go to treatment central 706, saving the user time in navigating the system. One field 707 will list various factors, such as teeth 708, face 710, symptoms 712, plaque 714, gingival recession 716, decay (small) 718, decay (extensive) 720, inadequate anatomy 722, impacted 724, current bite 726, pre-orthodontic 728, joints 730, muscles 732, tomograms 734, vertical 736, midlines 738, dentoskeletal 740, vertical 742 and projection to TVL (true vertical line) 744. Another field will include findings 750 associated with the various factors, and a third field 752 will list treatments 752 that follow from the findings 750.

With the system of the invention, a user can easily navigate through the various parts of the system, and can jump from module to module without having to go back through multiple pages. Furthermore, the system helps a health care provider to be provided with all the various treatment options available and the ability to automatically send reports to other health care providers. For example, an orthodontist, using the system, can decide that the patient has serious tooth decay and requires the services of a dentist and a periodontist. The system will permit the orthodontist to email detailed reports listing the orthodontist's recommend treatment(s) to other health care provider(s), thus saving valuable time in transferring medical files and allowing various health care providers to work more in concert in solving a patient's various issues.

The system of the invention permits a user to be apprised of the various treatment options for a variety of conditions in the various fields, and permits the user to even refer out other specialized examinations or treatments to other professionals.

With the computerized medical and dental diagnosis and treatment planning and management system of the invention, a health care provider, e.g., a surgeon, orthodontist, dentist, etc., can navigate through a menu-based computer program, and answer questions and enter data relevant to specific types of examinations. The health care provider also has the option to add in additional or custom examinations to the system. The answered questions and entered data in specific fields and on specific forms then populate data fields in other forms which can list at least some of the following items: diagnosed conditions and findings; possible treatment for those conditions and findings; specific actions that can be taken to attend to the diagnosed conditions and findings; and referrals to other professionals. Any change of data or entered information on any one form or data field will automatically update other related forms as needed.

Although specific examples have been given that are centered round the head and face, the system is applicable to other medical and health care fields where there is benefit to several persons working with the patient and his or her records.

The drawings in the foregoing description are not intended to represent the only form of the invention in regard to the details of its construction and manner of operation. In fact, it will be evident to one skilled in the art that modifications and variations can be made without departing from the spirit and scope of the invention. Although specific terms have been employed, they are intended in a generic and descriptive sense only and not for purposes of limitation.

1. A computerized medical and dental diagnosis and treatment planning and management system, comprising:
a computer program with fields for entering information related to a plurality of different types of examinations, wherein the entered information in specific fields for one type of examination will populate selected fields for other types of examinations.

2. The computerized medical and dental diagnosis and treatment planning and management system of claim 1, wherein computer program is menu based.

3. The computerized medical and dental diagnosis and treatment planning and management system of claim 1, wherein the information comprises at least one of answers to questions and measured data related to specific types of examinations.

4. The computerized medical and dental diagnosis and treatment planning and management system of claim 3, wherein the answers to questions and measured data is entered into specific fields on specific forms and then automatically populates data fields in a series of other forms for other types of examinations.

5. The computerized medical and dental diagnosis and treatment planning and management system of claim 1, wherein the at least one of answers to questions and measured data is related to at least one of diagnosed conditions and findings, possible treatment for those conditions and findings, specific action items that can be taken to attend to the diagnosed conditions and findings, and referrals to other professionals.

6. The computerized medical and dental diagnosis and treatment planning and management system of claim 1, wherein the information is electronically disseminated from a central system by a referring practitioner to other practitioners.

7. The computerized medical and dental diagnosis and treatment planning and management system of claim 4, wherein at least one of the information and forms are electronically disseminated from a central system by one treating practitioner to another practitioner who may render services to a patient.

8. The computerized medical and dental diagnosis and treatment planning and management system of claim 1, wherein the system identifies possible treatment options for a variety of conditions in the relevant fields.

9. The computerized medical and dental diagnosis and treatment planning and management system of claim 1, wherein the computer program comprises:
a chart central software system for storing data including patient data, information concerning various treatment options, and information concerning providers of goods and services; and
a diagnosis central system for aiding with patient diagnosis, which includes an examination form module for displaying examination information in a summary form, a referral central module for providing a summary of information and data pertinent to each professional being referred and what data is provided to that professional, and a procedure central summary form for summarizing the procedures, including the findings and treatment summaries.

10. The computerized medical and dental diagnosis and treatment planning and management system of claim 9, wherein the diagnosis central system has links to forms for information concerning at least one of patient motivation, periodontal examination, dental examination, bite examination, temporomandibular joint disorder examination, facial examination, cephalometric examination, and patient motivation.

11. The computerized medical and dental diagnosis and treatment planning and management system of claim 9, wherein the procedure central system includes fields for findings and fields for possible treatments.

12. A computerized medical and dental diagnosis and treatment planning and management system, comprising:
a menu based computer program with fields for entering information including answers to questions and measured data related to a plurality of different types of examinations, wherein the entered information in specific fields on specific forms for one type of examination will automatically populate selected data fields in a series of other forms for other types of examinations.

13. The computerized medical and dental diagnosis and treatment planning and management system of claim 12, wherein the answers to questions and measured data are related to at least one of diagnosed conditions and findings, possible treatment for those conditions and findings, specific action items that can be taken to attend to the diagnosed conditions and findings, and referrals to other professionals.

14. The computerized medical and dental diagnosis and treatment planning and management system of claim 12, wherein the forms for examinations are electronically disseminated from a central system by a referring practitioner to other practitioners.

15. The computerized medical and dental diagnosis and treatment planning and management system of claim 12, wherein the forms for examinations are electronically disseminated from a central system by one treating practitioner to other practitioners who render services to a patient.

16. The computerized medical and dental diagnosis and treatment planning and management system of claim 12, wherein the system identifies possible treatment options for a variety of conditions.

17. A computerized medical and dental diagnosis and treatment planning and management system, comprising:
a menu based computer program with fields for entering information including answers to questions and measured data related to a plurality of different types of examinations, wherein the entered information in specific fields on specific forms for one type of examination will automatically populate selected data fields in a series of other forms for other types of examinations, and wherein the forms for examinations are electronically disseminated from a central system by treating practitioners to other practitioners who render services to a patient.

18. The computerized medical and dental diagnosis and treatment planning and management system of claim 17, wherein the answers to questions and measured data are related to at least one of diagnosed conditions and findings, possible treatment for those conditions and findings, specific action items that can be taken to attend to the diagnosed conditions and findings, and referrals to other professionals.
